(19) United States
(12) Patent Application Publication
(10) Pub. No.: US 2010/0000258 A1
(43) Pub. Date: Jan. 7, 2010

(54) HEATING PROCESS AND APPARATUS OF MOLDING GLASS

(75) Inventors: Jeng-Ywan Jeng, Taipei (TW); Wei Wang, Nantou County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei (TW)

(21) Appl. No.: 12/497,698

(22) Filed: Jul. 5, 2009

(30) Foreign Application Priority Data
Jul. 7, 2008 (TW) 97125602

(51) Int. Cl. C03B 29/00; C03B 23/00

(52) U.S. Cl. 65/102; 65/275

(57) ABSTRACT

A heating process of molding a glass is provided. First, a first heat source is provided to heat up a glass preform in a mold directly and a second heat source is provided to heat up the mold directly. In the heating period using the first heat source, the glass preform is softened by heat and pressed with the mold, and in the pressing period using the mold, the glass preform is cooled down and formed as an optical lens.

### CROSS-REFERENCE TO RELATED APPLICATION

This application claims the priority benefit of Taiwan application serial no. 97125602, filed on Jul. 7, 2008. The entirety of the above-mentioned patent application is hereby incorporated by reference herein and made a part of specification.

### BACKGROUND OF THE INVENTION

1. Field of the Invention

The present invention relates to a method of molding and more particularly, to a heating method of molding a glass.

2. Description of Related Art

In recent years, the market of optical products such as digital cameras is developing rapidly. The demand for image quality is correspondingly increasing and the requirement for resolution of a mobile phone camera will also be raised to over a million pixels. Injection molded plastic optical lenses are no longer able to generate such image quality and thus, glass lenses have to be used. Specifically, aspheric and small-sized glass lenses are manufactured using a conventional polishing method which is difficult, slow, and uneconomical. Therefore, using a method of molding glass to manufacture aspheric and small-sized glass lenses is a certain future trend. The method may generate aspheric lenses of uniform quality and high precision in a massive quantity to meet industry requirements.

However, in the current molding process, a glass preform (referred as glass hereafter) is put into a mold and molded once to form a required optical lens under a high-temperature, high-pressure, and oxygen-free (protective gas or noble gas) condition. Control of factors such as temperature and pressure has a great effect on the precision of sizes after formation. A common method is to heat up a mold as well as the glass to a temperature close to the glass softening temperature and then apply pressure on the glass using the mold. Next, while maintaining pressure, the mold is cooled down to a temperature lower than the glass transition temperature. The method of heating up the mold and the glass at the same time and to the same temperature is called isothermal pressuring method, which has a disadvantage that the time required to heat up and cool down is long and thus, the speed of manufacturing is low. In addition, because a heat source is used to heat up the mold and then indirectly heat up the glass to the glass softening temperature, the lifetime of the mold is decreased due to damage from high temperature, also resulting in errors in size precision.

### SUMMARY OF THE INVENTION

The present invention provides a heating process and apparatus of molding a glass, in which glass is directly heated to reduce loss of thermal energy and increase process efficiency.

The present invention provides a heating process of molding a glass. First, a first heat source is provided to directly heat up a glass preform in a mold. A second heat source is provided to directly heat up the mold or the glass preform. In the heating period using the first and/or the second heat source, the glass preform is softened and pressed with the mold. In the pressing period using the mold, the glass preform is cooled down and formed as an optical lens.

The present invention provides a heating process of molding a glass. First, a first heat source is provided to directly heat up a glass preform in a mold. A second heat source is provided to directly heat up the mold. The first heat source and the second heat source have different ways of heat transfer. In the heating period using the first heat source, the glass preform is softened and pressed with the mold. The working temperature of the mold is lower than the glass softening temperature. In the pressing period using the mold, the glass preform is cooled down and formed as an optical lens.

The present invention provides an apparatus for molding a glass including a mold, at least a first heat source, a second heat source, and a pressure module. The mold comprises an upper die and a lower die used to place a glass preform between the upper die and the lower die. The first heat source is used to directly heat up the glass preform and the second heat source is used to heat up the mold. The pressure module is used to apply pressure to the mold to form the glass preform as an optical lens in the period of using the first heat source to soften the glass preform.

In one embodiment of the present invention, a first heat source applies heat by heat convection or heat radiation and the second heat source applies heat by heat conduction.

In one embodiment of the present invention, the glass preform has a higher absorption rate for the first heat source than for the second heat source.

In one embodiment of the present invention, the heating process using the first heat source includes heating up the glass preform to the glass softening temperature using a hot air gun or an infrared lamp.

In one embodiment of the present invention, the mold is placed inside a sleeve and a through hole is aligned with the position of the glass preform to allow hot air or heat radiation to pass the through hole and enter the sleeve.

The heating process of the present invention heats up the glass preform and the mold respectively using a first heat source and a second heat source which adopt different ways of heat transfer. The glass preform has a better absorption rate for heat convection and heat radiation so the heating process of the present invention does not have the disadvantage of heating up the glass preform indirectly through the mold in a conventional process, thereby reducing loss of thermal energy, increasing process efficiency, and prolonging lifetime of the mold.

In order to make the aforementioned and other objects, features and advantages of the present invention more comprehensible, several embodiments accompanied with figures are described in detail below.

### BRIEF DESCRIPTION OF THE DRAWINGS

FIG. 1 is a flow chart of a process and apparatus of molding a glass.

FIG. 2 is a schematic diagram of a heating device of molding a glass according to an embodiment of the present invention.

### DESCRIPTION OF EMBODIMENTS

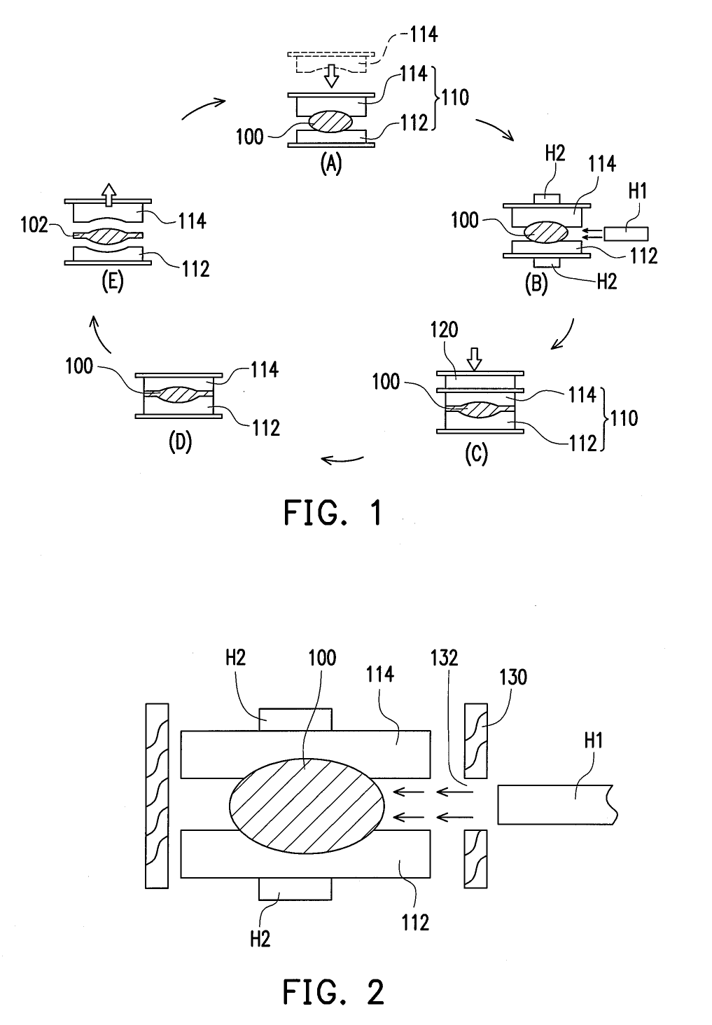

FIG. 1 is a flow chart of a method and apparatus of molding a glass. FIG. 2 is a schematic diagram of a heating device of molding a glass according to an embodiment of the present invention.

Referring to FIG. 1, the method of molding a glass mainly comprises a pre-step (A), a heating step (B), a pressuring step (C), a cooling down step (D), and a mold release step (E) etc. . . . First, at the pre-step (A), a spherical glass preform (referred as glass hereafter) 100 is placed on a lower die 112 of a mold 110 and then, the glass 100 is fixed between an upper die 114 and the lower die 112 using the upper die 114. Next, the glass 100 is placed in a heating chamber (not shown). A heater or another heat source is fixed on the mold 110 preferably at a position as close to the glass 100 as possible. Then, at the heating step (B), the glass 100 is directly heated and softened by using a first heat source H1. The mold 110 is directly heated to reach a working temperature by using a heater or another second heat source H2. Then, at the pressuring step (C), a pressure module 120 is used to apply pressure on the mold 110 to join the upper die 114 and the lower die 112 so that the glass 100 is formed as a lens. At the cooling down step (D), a pressure is maintained so as to prevent the glass 100 from deformation due to contraction when cooling down. Last, at the mold release step (E), the formed optical lens such as a lenticular lens, a biconcave lens, or an aspheric lens is taken out.

It should be noted that the conventional method of heating up the glass and the mold at the same time and to the same temperature results in disadvantages such as the working temperature of the mold being too high and the heating time and cooling time of the mold being too long. The heater heats up the mold using heat conduction so the mold and the glass have to be heated to a temperature close to the glass softening temperature at the same time to proceed to the pressuring step (C). However, in the process of indirectly heating the glass through the mold, part of the thermal energy is wasted on the mold instead of that all the thermal energy is used on the glass, resulting in slow heating. In addition, the lifetime of the mold is decreased due to damage from high temperature resulted from a high working temperature of the mold.

The present invention uses the first heat source H1 to directly heat up the glass without heating through the mold 110. All of the thermal energy is directly used on heating up the glass 100 so the temperature rises fast and the process efficiency is increased. In the present embodiment, the first heat source H1 heats up the glass 100 using heat convection or heat radiation. For example, at least a hot air gun or at least an infrared lamp is used to heat up the glass 100 to the glass softening temperature. Referring to FIG. 2, when a hot air gun is used for direct heating, hot air focuses and circulates around the glass 100 through a vent. The glass 100 is heated fast and softened under a high-temperature environment. The time required to heat up the glass 100 from a room temperature to the glass softening temperature may be greatly reduced to under 300 seconds. When an infrared lamp is used for direct heating, heat is conducted through radiation to increase the temperature of the glass. For example, a suitable medium may be used to conduct the radiation of infrared to the glass 100 to increase the absorption rate of heat radiation. Furthermore, in order to increase the surrounding temperature of the glass 100, the mold 110 may be placed in a sleeve 130 and a through hole 132 is kept aligned with the position of the glass 100 so that the heat of hot air or infrared may enter the sleeve 130 through the through hole 132 to directly heat up the glass 100.

The glass 100 has a better absorption rate toward heat convection or heat radiation. The heat radiation at near infrared wavelength may make the internal and external temperatures of the glass to quickly and uniformly rise to the glass softening temperature. Compared to heating with a heater or another second heat source H2 which applies heat by heat conduction and the heat has to be conducted from the outside toward the center, resulting in the external and internal temperatures of the glass not being uniform, the present invention uses the first heat source H1 adopting heat convection or heat radiation to directly heat up the glass 100 and thus the absorption rate is increased and the external and internal temperatures are uniform.

In addition, the time required to heat up the mold 110 using a heater or another second heat source H2 to the working temperature may be shortened. The working temperature of the mold 110 may be lower than the glass softening temperature of the glass 100. For example, the working temperature may be decreased from the original 700° C. to 630° C. or even lower. Thus, the lifetime of the mold 110 may be prolonged.

In summary, the heating process of the present invention heats up the glass and the mold respectively using a first heat source and a second heat source which adopt different ways of heat transfer. The glass has a better absorption rate for heat convection or heat radiation so the heating process of the present invention does not have the disadvantage of heating up the glass indirectly through the mold in a conventional process, thereby reducing loss of thermal energy, increasing process efficiency, and prolonging lifetime of the mold.

It will be apparent to those of ordinary skills in the technical field that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A heating process of molding glass, comprising:
providing at least a first heat source to directly heat up a glass preform in a mold;
providing a second heat source to directly heat up the mold or the glass preform;
softening the glass preform and pressing the glass preform with the mold in the heating period using the first and/or the second heat source; and
cooling down the glass preform and forming the glass preform as an optical lens in the pressing period using the mold.

2. The heating process of molding glass according to claim 1, wherein the first heat source applies heat by heat convection or heat radiation and the second heat source applies heat by heat conduction.

3. The heating process of molding glass according to claim 1, wherein the glass preform has a greater heat absorption rate for the first heat source than that for the second heat source.

4. The heating process of molding glass according to claim 1, wherein the heating period using the first heat source comprises using a hot air gun to heat up the glass preform to the glass softening temperature.

5. The heating process of molding glass according to claim 1, wherein the heating period using the first heat source comprises using an infrared lamp to heat up the glass preform to the glass softening temperature.

6. A heating process of molding glass, comprising:
providing a first heat source to directly heat up a glass preform in a mold;
providing a second heat source to directly heat up the mold, wherein the first heat source and the second heat source have different ways of heat transfer;
softening the glass preform and pressing the glass preform with the mold in the heating period using the first heat source, wherein the working temperature of the mold is lower than the glass softening temperature of the glass preform; and
cooling down the glass preform and forming the glass preform as an optical lens in the pressing period using the mold.

7. The heating process of molding glass according to claim 6, wherein the first heat source applies heat by heat convection or heat radiation and the second heat source applies heat by heat conduction.

8. The heating process of molding glass according to claim 6, wherein the glass preform has a greater heat absorption rate for the first heat source than that for the second heat source.

9. The heating process of molding glass according to claim 6, wherein the heating period using the first heat source comprises using a hot air gun to heat up the glass preform to the glass softening temperature.

10. The heating process of molding glass according to claim 6, wherein the heating period using the first heat source comprises using an infrared lamp to heat up the glass preform to the glass softening temperature.

11. An apparatus of molding glass, comprising:
a mold, comprising an upper die and a lower die used to place a glass preform between the upper die and the lower die;
at least a first heat source, used to directly heat up the glass preform;
a second heat source, used to heat up the mold; and
a pressure module, used to apply pressure to the mold to form the glass preform as an optical lens in the period of using the first heat source to soften the glass preform.

12. The apparatus of molding glass according to claim 11, further comprising a sleeve placed outside the mold and including a through hole aligned with the position of the glass preform.

13. The apparatus of molding glass according to claim 11, wherein the first heat source applies heat by heat convection or heat radiation.

14. The apparatus of molding glass according to claim 11, wherein the first heat source comprises a hot air gun or an infrared lamp.

15. The apparatus of molding glass according to claim 11, wherein the second heat source applies heat by heat conduction.
